(19) United States
(12) Patent Application Publication
(10) Pub. No.: US 2007/0167618 A1
(43) Pub. Date: Jul. 19, 2007

(54) Manufacture of cellulose esters: recycle of caustic and/or acid from pre-treatment of pulp

(75) Inventors: Linfu Wang, Blacksburg, VA (US); Henry P. Stogner, Bluefield, WV (US); Denis G. Fallon, Blacksburg, WV (US); Lawton E. Kizer, Blacksburg, VA (US); Charles E. Toney, Newport, VA (US); Billy C. Batson, Pearisburg, VA (US)

Correspondence Address: HAMMER & HANF, PC, 3125 SPRINGBANK LANE, SUITE G, CHARLOTTE, NC, 28226, US

(73) Assignee: Celanese Acetate, LLC

(21) Appl. No.: 11/332,741

(22) Filed: Jan. 13, 2006

(51) Int. Cl. C08B 3/22

(52) U.S. Cl. 536/76

(57) ABSTRACT

A process for the manufacture of cellulose esters is described. The process includes the steps of: pre-treating pulp for the removal of impurities with either caustic or acid or both, esterifying the pre-treated pulp, and recycling the caustic or acid or both from the pre-treating step.

### FIELD OF THE INVENTION

The present invention is directed to the recycle of caustic and/or acid from the pre-treatment of pulps used in the manufacture of cellulose esters.

### BACKGROUND OF THE INVENTION

Generally, in the manufacture of cellulose esters, cellulose (typically from cotton linters or high grade wood pulps) is opened, activated, esterified, and, optionally, de-esterified to a level of esterification less than 100% of the cellulose.

High grade wood pulps refer to cellulose sources that contain high amount of alpha cellulose and few impurities. Impurities mainly include hemicelluloses (e.g., xylans and mannans), lignins, and resins (also called organic solvent extractives, and include, e.g., fatty acids, fatty alcohols, fatty esters, rosins and waxes). For example, a typical “acetate” grade pulp contains >95% alpha cellulose and 1-3% hemicellulose; a typical “viscose” grade pulp contains 90-95% alpha cellulose and 4-5% hemicellulose; and “paper/fluff” grade pulp contains about 80% alpha cellulose and 15-20% hemicellulose. Of course, higher grade pulps are more expensive than lower grade pulps. There is a desire to use lower grade pulps, but the lower grade pulps are detrimental to production and quality of the resulting cellulose esters.

Opening, activation, esterification, and optionally de-esterification of the cellulose esters will be briefly described with reference to cellulose acetate, but the invention is not so limited. Opening and activation refers to the wetting or soaking of shredded pulp in a weak acid, such as acetic acid; removal of impurities is not the purpose of this step. Esterification (or acetylation) refers to the replacement of substantially 100% (degree of substitution, D.S.=3) of the hydroxyl (OH) groups on the cellulose backbone with acetyl groups by reaction of the activated cellulose with acetic anhydride. De-esterification (or hydrolysis or ripening) refers to the replacement of some of the acetyl groups with OH groups (typically degree of substitution between 2.1 and 2.7) by reaction with water.

In U.S. patent application Ser. No. 11/155,133 filed Jun. 16, 2005, a process for the manufacture of cellulose esters with lower grade wood pulps is disclosed. This process replaces the previously known opening and activation (sometimes called pre-treatment) step with a new pre-treatment where the lower grade wood pulp is treated with a caustic solution and then washed with water and acid before esterification. This new process enables the production of cellulose esters from lower grade wood pulps, but avoids the production and quality problems previously encountered by the use of lower grade pulps. The caustic and acid used in this step can be substantial; therefore, it cannot be discarded, but must be recycled to improve the economics of the process.

Accordingly, there is a need for a process to recycle the caustic and/or acid from the pre-treatment of wood pulps used in the manufacture of cellulose esters.

### SUMMARY OF THE INVENTION

A process for the manufacture of cellulose esters is described. The process includes the steps of: pre-treating pulp for the removal of impurities with either caustic or acid or both, esterifying the pre-treated pulp, and recycling the caustic or acid or both from the pre-treating step.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a detailed flow chart illustrating an embodiment of the present invention.

### DESCRIPTION OF THE INVENTION

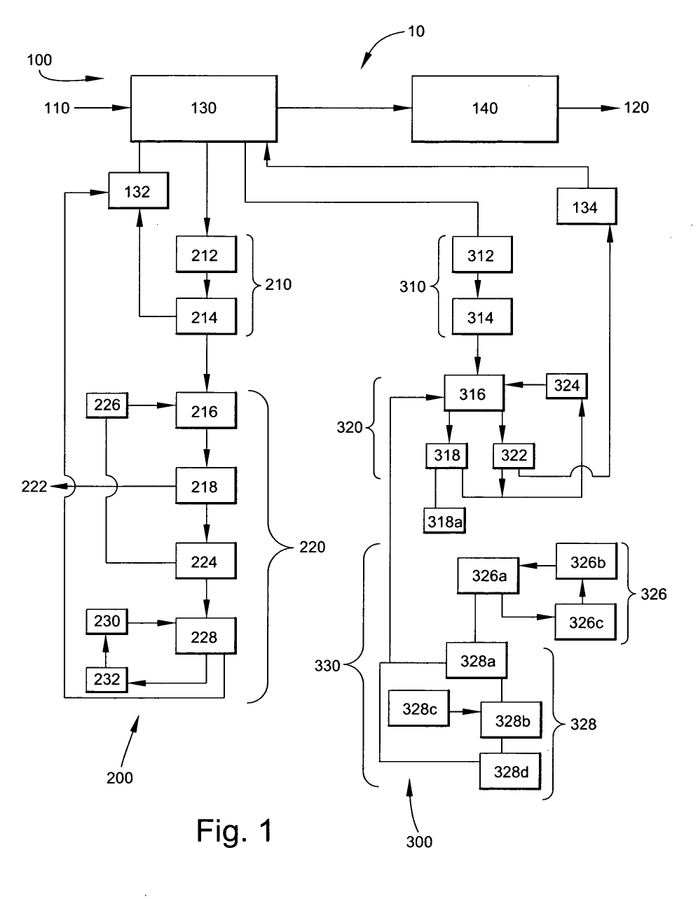

Referring to FIG. 1, there is shown a flow chart 10 of an embodiment of the present invention. The process illustrated in 10 may be broken down into three components: pulp pre-treatment and cellulose manufacture 100, caustic recycle 200, and acid recycle 300. Each of these components will be discussed in greater detail below.

Cellulose esters, as used herein, refers to, but is not limited to, cellulose acetates, cellulose propionates, cellulose butyrates, cellulose valerates, cellulose formates, and co-polymers thereof. Co-polymers include, but are not limited to, acetates-propionates or butyrates or valerates or formates and the like. For the following discussion of the invention, reference will be made to cellulose acetate, but the invention is not so limited.

Pre-treatment and cellulose ester manufacture 100 refers to that part of the process where wood pulp 110 is reacted with acetic anhydride to form cellulose acetate 120. Wood pulp 110 refers to any grade of wood pulp. Wood pulps of lower grades, other than cotton linters and “acetate” grade pulps, would have the greatest benefit in this process. Those grades include: “viscose” and “paper/fluff”, as mentioned above, or generally, pulps having an alpha cellulose content of <95% and impurities >5%. Cellulose acetate refers to cellulose acetate polymer having a degree of substitution in the range of 2.1 to 2.7.

This process 100 may be broken down into two steps: pulp pre-treatment 130 and cellulose acetate manufacture 140. Pulp pre-treatment 130 refers to the treatment of pulp 110 with caustic and subsequent washings with water and acid for the removal of impurities. This process is fully discussed in U.S. patent application Ser. No. 11/155,133 filed Jun. 16, 2005 and is incorporated herein by reference. Generally, the pre-treatment step involves: mixing wood pulp with a caustic solution (e.g., an alkali metal hydroxide solution including but not limited to, NaOH, KOH and mixtures thereof), separating the pulp from the solution and forming a cake, washing the cake with water, and washing the cake with acid solution (e.g., acetic acid solution) to obtain a pulp suitable for esterification.

Cellulose acetate manufacture 140 refers to the reaction (acetylation or more generally esterification) of pulp from the foregoing pre-treatment step 130 with, for example, acetic anhydride to form cellulose triacetate, and subsequently removing (hydrolysis or more generally de-esterification) some of the acetyl groups to form cellulose acetate (D.S. 2.1-2.7). This step is well known by those of ordinary skill in the art.

In the caustic recycle 200 and the acid recycle 300 discussed below, hemicellulose is the impurity component that is primarily removed; other impurities may also be removed.

Caustic recycle 200 refers to that part of the process where caustic solution containing dissolved compounds (i.e., hemicellulose) that are removed from the pulp during pre-treatment step 130 is treated to remove the impurities, so that the caustic may be recycled back into pre-treatment step 130. This step will be discussed in greater detail below.

Caustic solution includes any caustic solution formed with a strong alkaline material, and may be formed with caustic soda or sodium hydroxide or potassium hydroxide or mixtures thereof. The caustic solution may range from 1-50% by weight caustic, and in another embodiment may range from 1-18% by weight caustic.

Caustic recycle 200 may be broken down into two major components: a filtration step 210 and a caustic recovery step 220. Each step will be discussed in greater detail below.

Filtration step 210, in one embodiment, comprises a pre-filtration step 212, and a nano-filtration step 214. Either filtration step is optional.

Pre-filtration step 212 is designed to remove insoluble cellulose fines and fibers that may be harmful to the subsequent nano-filtration step and to prevent the passage of particles having a size of about 5 microns or greater. Pre-filtration step 212 may be any conventional filter and made of material adapted to withstand the caustic conditions. Exemplary pre-filtration units include, but are not limited to, bag filters, ribbon filters, pressure leaf filters, self-cleaning or back-flushable filters, and other liquid/solid separation equipment, such as centrifuges.

Nano-filtration step 214 is to concentrate the impurities from the caustic solution into a smaller volume stream for subsequent removal in a more economical fashion. The nano-filtration refers to a separation technique for materials lying between the ultrafiltration range and the reverse osmosis range. Nano-filtration has good rejection rates for organic compounds having molecular weights above 150-500 grams/mole. This makes nano-filtration a good method of removing most of the impurities found in the caustic solution from the pre-treatment step 130. About 80-90% of the caustic solution leaving the nano-filtration step 214 (or permeate) may be directly recycled back to the pre-treatment step 130, via caustic supply 132.

Nano-filtration step 214, in one embodiment, may be further characterized as follows. Nano-filtration membranes that are known in the art may be used, so long as they can withstand the elevated temperatures of the caustic solution. Exemplary membranes are made of, for example, polysulfone, polyether sulfone, polyvinylidene fluoride, polytetrafluoroethylene, polypropylene and mixtures thereof. The operating temperature, in one embodiment, is about 70° C. and above. The operating pressure is sufficiently high enough to provide adequate flow through the membrane and in one embodiment the hydrostatic operating pressure is about 100 psig to about 500 psig, and, in another embodiment, about 300 psig to 450 psig. The configuration of nano-filtration unit may be spiral wound membranes, tubular arrays of hollow fibers, and the like.

The caustic recovery step 220 is for removing impurities from the concentrate produced by the filtration step 210, so that the caustic may be recycled back to the pre-treatment step 130. This concentrate, which comprises about 10-20% of the caustic entering the filtration step, comprises caustic solution and impurities. In one embodiment, the impurities are precipitated from the caustic solution 216.

In precipitation step 216, the caustic solution containing impurities from the filtration step 210 is contacted with precipitating agent from supply 226. The precipitating agent may be any alcohol, ketone, or mixture thereof. The most suitable alcohols are from the family of alcohols containing 1-4 carbons. In one embodiment, either methanol and/or ethanol may be used. In the embodiment where methanol is used, precipitation may be conducted at temperatures up to 64° C. under atmospheric pressure. The weight ratio of methanol/caustic solution may be from 0.8-20:1, or in another embodiment 3:1, or in another embodiment 1:1. Ketone includes, but is not limited to, acetone, methyl ethyl ketone, diisobutyl ketone, methyl amyl ketone, and the like. Precipitation may be conducted with or without stirring. The suspension obtained from the precipitation may be held up to 24 hours, but in one embodiment it is held for up to 4 hours. In one embodiment, precipitation is improved (accelerated by improved nucleation) by the use of flocculants (e.g., Ca(OH)₂) or sludge recirculation.

In the separation step 218, the suspension obtained from the precipitation step 216 is separated into a solid stream 222 and a liquid (caustic/alcohol) stream. The solid stream 222 may be recovered for commercial use or disposed of in any conventional manner. The liquid stream is sent on for further processing, discussed below. In one embodiment, the separation step 218 is accomplished by the use of any conventional solid/liquid equipment, for example, a centrifuge, vacuum filtration, and pressure filtration.

In separation step 224, the caustic/alcohol stream from the step 218 is separated into a caustic stream and an alcohol stream. Separation step 224, in one embodiment, is accomplished by distillation with or without vacuum. Such a distillation is conventional and well understood in the art. The alcohol stream obtained may be directly recycled back to precipitation step 216 via alcohol supply 226. The caustic stream obtained may be subjected to further processing, as discussed below.

In a final impurities removal step 228, impurities in the caustic stream from separation step 224 are removed. In this final removal step, the impurities may be removed by either an extraction technique, shown in the figure, or an adsorption technique (e.g., adsorption using carbon-based (e.g., activated carbon), or polymer-based (e.g., slightly crossed-linked, macromolecular polystrenes and polyacrylics adsorbents), not shown in the figure.

In the extraction technique, an extraction agent from supply 230 is mixed with the caustic solution to form an agent/impurities layer and a caustic solution layer. The former may be decanted from the latter. Exemplary extraction agents include, but are not limited to, hexane, pentane, heptane, and mixtures thereof. Exemplary mixing ratios of extracting agents to caustic range from 0.2:1 to 10:1 in one embodiment, and 0.5 to 5:1 in another embodiment. Exemplary mixing conditions include, but are not limited to, extensive mixing, and stirring for about 10 minutes at temperature up to 69° C. The caustic solution may be directly recycled back to the pre-treatment step 130 via caustic supply 132. If necessary, the agent/impurities layer may be purified 232 (i.e., removal of impurities, when it reaches a DME (dichloromethane) extractive of 0.2% or higher) by, for example, evaporation and condensation in a known manner.

Acid recycle 300 provides for the recycle of acid, parts of which are optional and may not be necessary if sufficient impurities are removed in the caustic wash step of the pulp pre-treatment step 130. In one embodiment, the acid solution comprises acetic acid and water. Acid recovery step 300, in one embodiment, may be direct distillation of the acid from the acid stream (comprising, for example, 10-40% by weight acid, 60-90% by weight water, and minor amounts of impurities) from the pre-treatment step 130. Acid recovery step 300, in another embodiment, may be solids removal followed by extraction of the acid with a solvent(s) and separation of the acid/solvent mixture. This latter embodiment shall be discussed in greater detail below.

Acid recycle 300 may be broken down into three major components: a filtration step 310 (optional), an acid filtrate recovery step 320, and an acid concentrate recovery step 330 (optional). Each step will be discussed in greater detail below.

Filtration step 310, in one embodiment, comprises a pre-filtration step 312, and a nano-filtration step 314. Either filtration step is optional.

Pre-filtration step 312 is designed to remove insoluble cellulose fines and fibers that may be harmful to the subsequent nano-filtration step and to prevent the passage of particles having a size of about 5 microns or greater. Pre-filtration step 312 may be any conventional filter and made of material adapted to withstand the acidic conditions. Exemplary pre-filtration units include, but are not limited to, bag filters, ribbon filters, pressure leaf filters, self-cleaning or back-flushable filters, and other liquid/solid separation equipment, such as centrifuges.

Nano-filtration step 314 is to concentrate the impurities from the acid solution into a smaller volume stream for subsequent removal in a more economical fashion. The nano-filtration refers to a separation technique for materials lying between the ultrafiltration range and the reverse osmosis range. Nano-filtration has good rejection rates for organic compounds having molecular weights above 150-500 grams/mole. This makes nano-filtration a good method of removing most of the impurities found in the acid solution from the pre-treatment step 130.

Nano-filtration step 314, in one embodiment, may be further characterized as follows. Nano-filtration membranes are known in the art may be used, so long as they can withstand the elevated temperatures of the acid solution. Exemplary membranes are made of, for example, polysulfone, polyether sulfone, polyvinylidene fluoride, polytetrafluoroethylene, polypropylene and mixtures thereof. The operating temperature, in one embodiment, is about 70° C. and above. The operating pressure is sufficiently high enough to provide adequate flow through the membrane and in one embodiment the hydrostatic operating pressure is about 100 psig to about 500 psig, and, in another embodiment, about 300 psig to 450 psig. The configuration of nano-filtration unit may be spiral wound membranes, tubular arrays of hollow fibers, and the like.

Acid filtrate recovery 320 is used to separate acid from water, so that acid may be recycled. In one embodiment, acid is separated from water by solvent extraction 316 followed by distillation 318 of the water/solvent stream and distillation 322 of the acid/solvent stream. The acid/water filtrate from filtration step 310 is contacted with a solvent from solvent supply 324. Solvent is any solvent or mixture of solvents that is miscible with the acid, but has minimal water solubility. Exemplary solvents include, but are not limited to, benzene, diethyl ether, diisobutyl ketone, ethyl acetate, methyl amyl ketone, methyl ethyl ketone, methyl t-butyl ether (MTBE), C-6 hydrocarbons, isopropyl acetate, isobutyl acetate, isopropyl ether.

Distillation 318 of the solvent/water stream resolves the mixture into water 318a and solvent, the latter may be recycled back to solvent supply 324. This distillation is conventional.

Distillation 322 of the solvent/acid stream resolves the mixture into acid and solvent, the former may be recycled back to acid supply 134. This distillation is conventional. The solvent may also contain residual water and may be recycled back to supply 324.

Acid concentrate recovery 330 is used to separate impurities form the acid solution from the filtration step 310, if necessary. Acid concentrate recovery 330, in one embodiment, may be broken down into two components: first removal of impurities from the concentrate 326, and second removal of impurities from concentrate 328.

The first removal of impurities 326 may utilize the solvent extraction 326a of impurities. As in the caustic recovery stream discussed above, an extraction agent 326b is used to remove the impurities in a conventional manner. Exemplary extraction agents include, but are not limited to, hexane, pentane, heptane, and mixtures thereof. Exemplary mixing ratios of extracting agents to caustic range from 0.2:1 to 10:1 in one embodiment, and 0.5 to 5:1 in another embodiment. Exemplary mixing conditions include, but are not limited to, extensive mixing, and stirring for about 10 minutes at temperature up to 69° C. Subsequent recovery of the extraction agent 326c may be accomplished in a conventional manner.

The second removal of impurities 328 may utilize an evaporation or distillation technique 328a. Removal step 328 is directed at removing any hemicellulose or other impurities that may slip by the forgoing steps. The stream relatively free of impurities may be recycled back to the extraction step 316. The other stream may be evaporated to dryness or subjected to a chemical neutralization 328b; both are carried out in a conventional manner. Chemical neutralization may be accomplished by use of neutralization agents from 328c, such as sodium hydroxide, calcium oxide, calcium hydroxide, magnesium oxide, magnesium hydroxide, and mixtures thereof. The liberation of the acetic acid from the acetic acid salt produced by the neutralization may be accomplished by utilizing a strong acid and filtration 328d. Such strong acids including but not limited to, sulfuric acid, nitric acid, hydrochloric acid and combinations thereof.

The present invention may be embodied in other forms without departing from the spirit and the essential attributes thereof, and, accordingly, reference should be made to the appended claims, rather than to the foregoing specification, as indicated the scope of the invention.

We claim:

1. In a process for the manufacture of cellulose esters wherein the process comprising the steps of pre-treating pulp for the removal of impurities with either caustic or acid or both and esterifying the pretreated pulp, the improvement comprising the steps of:
recycling the caustic or acid or both from a stream from the pre-treating step.

2. The process of claim 1 wherein recycling caustic further comprising:
filtering the caustic stream from the pre-treating step; and
recovering caustic to form a filter concentrate.

3. The process of claim 1 wherein recycling further comprises the steps of:
filtering impurities from the caustic stream from the pre-treating step, and
forming a filtrate for return to the pre-treating of pulp and a concentrate.

4. The process of claim 3 wherein filtering comprises the step of:
nano-filtering impurities from the caustic stream.

5. The process of claim 3 wherein filtering comprises the steps of:
pre-filtering particles having a predetermined size from the caustic stream,
nano-filtering impurities from the pre-filtered caustic stream, and
returning the filtrate from the nano-filtering to pre-treating the pulp.

6. The process of claim 5 wherein the predetermined size being selected from the group consisting of a particle size of >5 microns.

7. The process of claim 3 further comprising the step of:
precipitating impurities from the concentrate with a precipitating agent and forming precipitated impurities and a mixture of precipitating agent and caustic.

8. The process of claim 7 wherein the precipitating agent being selected from the group consisting of alcohol, ketone, and mixtures thereof.

9. The process of claim 8 wherein the alcohol being selected from the group consisting of alcohols containing 1 to 4 carbons.

10. The process of claim 8 wherein the ketone being acetone.

11. The process of claim 7 further comprising the step of:
separating precipitated impurities from the mixture of precipitating agent and caustic.

12. The process of claim 7 further comprising the step of:
separating the precipitating agent from the mixture of precipitating agent and caustic and forming a precipitating agent stream and a caustic stream.

13. The process of claim 12 wherein separating being distilling.

14. The process of claim 12 further comprising the step of:.
removing impurities from the caustic stream prior to returning the caustic to the pre-treating of the pulp.

15. The process of claim 14 wherein removing being selected from the group consisting of extracting and adsorbing.

16. The process of claim 1 wherein recycling further comprising the steps of:
distilling the acid from the pre-treating step.

17. The process of claim 1 wherein recycling further comprising the steps of:
filtering the acid from the pre-treating step and forming a filtrate stream and a concentrate stream;
separating acid from the filtrate stream; and
separating acid from the concentrate stream.

18. The process of claim 1 wherein recycling further comprises the steps of:
filtering impurities from the acid stream from the pre-treating step, and
forming a filtrate and a concentrate.

19. The process of claim 18 wherein filtering comprises the step of:
nano-filtering impurities from the acid stream.

20. The process of claim 18 wherein filtering comprises the steps of:
pre-filtering particles having a predetermined size from the acid stream, and
nano-filtering impurities from the pre-filtered acid.

21. The process of claim 20 wherein the predetermined size being selected from the group consisting of a particle size of >5 microns.

22. The process of claim 18 wherein recycling further comprises extracting acid from the filtrate.

23. The process of claim 22 wherein extracting further comprising contacting the acid stream with a solvent.

24. The process of claim 23 wherein the solvent being selected from the group consisting of benzene, diethyl ether, diisobutyl ketone, ethyl acetate, methyl amyl ketone, methyl ethyl ketone, methyl t-butyl ether (MTBE), C-6 hydrocarbons, isopropyl acetate, isobutyl acetate, isopropyl ether, and mixtures thereof.

25. The process of claim 23 further comprising separating acid from an acid/solvent stream.

26. The process of claim 18 wherein recycling further comprises extracting acid from the concentrate.

27. The process of claim 26 wherein extracting further comprising contacting the acid stream with a solvent.

28. The process of claim 27 wherein the solvent being selected from the group consisting of hexane, pentane, heptane, and mixtures thereof.

29. The process of claim 16 further comprising the step of removing any residual impurities.

30. The process of claim 29 wherein said impurities being organic solvent extractives.
